(19) United States
(12) Patent Application Publication
(10) Pub. No.: US 2015/0323017 A1
(43) Pub. Date: Nov. 12, 2015

(54) VEHICLE CLUTCH SYSTEM INCLUDING THRUST BEARING LOAD CELL

(71) Applicant: FORD GLOBAL TECHNOLOGIES, LLC, Dearborn, MI (US)

(72) Inventors: Jon O'Neill, Erith (GB); Anthony Osborne, Romford (GB)

(73) Assignee: FORD GLOBAL TECHNOLOGIES, LLC, Dearborn, MI (US)

(21) Appl. No.: 14/271,771

(22) Filed: May 7, 2014

(51) Int. Cl. F16D 25/12; F16D 13/58

(52) U.S. Cl. CPC F16D 25/12; F16D 13/58

(57) ABSTRACT

A clutch system according to an exemplary aspect of the present disclosure includes, among other things, a thrust bearing and a load sensor positioned relative to the thrust bearing and configured to measure a load exerted against the thrust bearing.

### TECHNICAL FIELD

This disclosure relates to a vehicle, and more particularly, but not exclusively, to a vehicle clutch system that includes a thrust bearing and a load cell configured to directly measure driveline engagement and disengagement loads exerted against the thrust bearing.

### BACKGROUND

Stop/start technology is known for selectively shutting down a vehicle engine during portions of a drive cycle to conserve fuel and reduce emissions. For example, a stop/start vehicle can turn its engine off while the vehicle is stopped rather than allow the engine to idle. The engine can subsequently be restarted when a driver depresses the accelerator pedal or when the vehicle is otherwise able to progress.

For a variety of reasons, current restart strategies for stop/start vehicles have not resulted in extended stop/start operating ranges. The relatively harsh operating conditions of the clutch system that engages and disengages the engine from the transmission of the vehicle during the stop/start process have necessitated the use of relatively complex inferred or remote driveline detection techniques. However, in order to extend operating ranges of stop/start vehicles, a more direct manner of detecting driveline engagement/disengagement is desirable.

### SUMMARY

A clutch system according to an exemplary aspect of the present disclosure includes, among other things, a thrust bearing and a load sensor positioned relative to the thrust bearing and configured to measure a load exerted against the thrust bearing.

In a further non-limiting embodiment of the foregoing clutch system, the load sensor is positioned against a rear face of the thrust bearing.

In a further non-limiting embodiment of either of the foregoing clutch systems, the thrust bearing includes a front face that is rotatable and a rear face that is not rotatable.

In a further non-limiting embodiment of any of the foregoing clutch systems, a concentric slave cylinder includes a housing and a guide that protrudes from the housing.

In a further non-limiting embodiment of any of the foregoing clutch systems, the guide extends through a bore of each of the thrust bearing and the load sensor.

In a further non-limiting embodiment of any of the foregoing clutch systems, a dust shield is positioned between the thrust bearing and a concentric slave cylinder.

In a further non-limiting embodiment of any of the foregoing clutch systems, a piston is positioned between the thrust bearing and a concentric slave cylinder.

In a further non-limiting embodiment of any of the foregoing clutch systems, a spring is received over a guide of a concentric slave cylinder.

In a further non-limiting embodiment of any of the foregoing clutch systems, the load sensor is positioned between the thrust bearing and the spring.

In a further non-limiting embodiment of any of the foregoing clutch systems, the load sensor is positioned between the spring and the concentric slave cylinder.

In a further non-limiting embodiment of any of the foregoing clutch systems, wiring electrically connects the load sensor to a control unit of the clutch system.

In a further non-limiting embodiment of any of the foregoing clutch systems, the load sensor is positioned remotely from a front face of the thrust bearing but is configured to measure the load applied directly at the front face.

A vehicle according to another exemplary aspect of the present disclosure includes, among other things, an engine, a transmission operably connectable to the engine and a clutch system that selectively couples the transmission to the engine. The clutch system includes a concentric slave cylinder assembly that includes a load sensor configured to measure a load.

In a further non-limiting embodiment of the foregoing vehicle, the load sensor is configured to measure a load exerted against a front face of a thrust bearing of the concentric slave cylinder assembly.

In a further non-limiting embodiment of either of the foregoing vehicles, the concentric slave cylinder assembly includes a thrust bearing, a piston, a dust shield, a spring, and a concentric slave cylinder.

In a further non-limiting embodiment of any of the foregoing vehicles, the load sensor is positioned between the thrust bearing and the spring.

In a further non-limiting embodiment of any of the foregoing vehicles, the load sensor is positioned between the spring and the concentric slave cylinder.

In a further non-limiting embodiment of any of the foregoing vehicles, the load sensor is positioned remotely from a front face of a thrust bearing of the concentric slave cylinder assembly.

In a further non-limiting embodiment of any of the foregoing vehicles, the vehicle is a micro-hybrid vehicle that includes a stop/start system for selectively shutting down the engine during idling conditions.

A method according to another exemplary aspect of the present disclosure includes, among other things, incorporating a load sensor into a clutch system of a vehicle and measuring a load exerted against a thrust bearing of the clutch system with the load sensor.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of a vehicle.

FIG. 2 illustrates portions of a clutch system of a vehicle.

FIG. 3 illustrates a concentric slave cylinder assembly of a clutch system.

FIG. 4 illustrates a front view of the concentric slave cylinder assembly of FIG. 3.

FIG. 5 illustrates an exploded view of the concentric slave cylinder assembly of FIG. 3.

FIG. 6 illustrates another concentric slave cylinder assembly.

### DETAILED DESCRIPTION

This disclosure relates to a clutch system for a vehicle. The clutch system includes a thrust bearing, a concentric slave cylinder and a load cell positioned between the thrust bearing and the concentric slave cylinder. Incorporating the load cell into the clutch system enables a direct measurement of a load exerted against the thrust bearing during engagement and disengagement of a transmission input shaft relative to an engine flywheel. These and other features are discussed in greater detail herein.

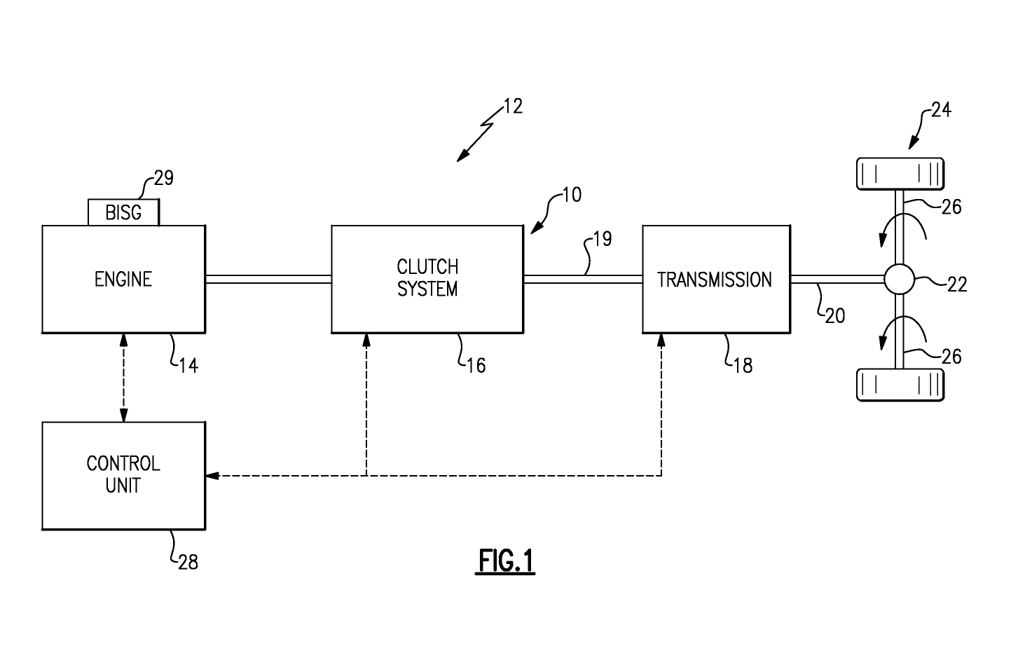

FIG. 1 schematically illustrates a powertrain 10 of a vehicle 12. The vehicle 12 could be any type of vehicle. In one non-limiting embodiment, the vehicle 12 is a micro-hybrid vehicle that can employ stop/start technology. The vehicle 12 may be a rear wheel drive, front wheel drive, or all-wheel drive vehicle.

The powertrain 10 may include an engine 14, a clutch system 16 and a transmission 18. The engine 14 may be selectively engaged and/or disengaged relative to the transmission 18 by the clutch system 16.

The engine 14 can be employed as an available drive source for the vehicle 12. In one embodiment, the engine 14 is an internal combustion engine. Although not shown in this embodiment, the powertrain 10 could be equipped with additional propulsion devices, such as an electric machine (i.e. a motor, generator, or combined motor/generator), such as within hybrid vehicle embodiments.

The transmission 18 may be a manual or an automatic transmission. The transmission 18 may include a gearbox having multiple gear sets (not shown) that are selectively operated using different gear ratios by selective engagement of friction elements such as clutches and brakes (not shown) to establish desired multiple discrete or step drive ratios. The friction elements are controllable through a shift schedule that connects and disconnects certain elements of the gear sets to control the ratio between a transmission input shaft 19 and a transmission output shaft 20 of the transmission 18.

The transmission 18 provides powertrain output torque to the transmission output shaft 20. The transmission output shaft 20 may be connected to a differential 22. The differential 22 drives a pair of wheels 24 via respective axles 26 that are connected to the differential 22 to propel the vehicle 12.

The powertrain 10 may additionally include an associated control unit 28. While schematically illustrated as a single controller, the control unit 28 may be part of a larger control system and may be controlled by various other controllers throughout the vehicle 12, such as a vehicle system controller (VSC) that includes a powertrain control unit, a transmission control unit, an engine control unit, etc. It should therefore be understood that the control unit 28 and one or more other controllers can collectively be referred to as a “control unit” that controls, such as through a plurality of interrelated algorithms, various actuators in response to signals from various sensors to control functions such as stopping/starting the engine 14, selecting or scheduling shifts of the transmission 18, actuating the clutch system 16, etc. In one embodiment, the various controllers that make up the VSC may communicate with one another using a common bus protocol (e.g., CAN). In one embodiment, the control unit 28 is in electrical communication with each of the engine 14, the clutch system 16 and the transmission 18 for controlling the powertrain 10.

In one exemplary stop/start sequence of the vehicle 12, the engine 14 can be automatically shut down during times when the vehicle 12 is not moving and then automatically restarted as necessary when the vehicle 12 begins to move again or when it becomes necessary to operate accessories off of the engine 14. In this regard, the vehicle 12 may include an automatic stop/start system that automatically shuts down and restarts the engine 14 to reduce the amount of time the engine spends idling, thereby reducing fuel consumption and emissions. Automatically shutting down the engine 14 can be advantageous for vehicles that spend significant amounts of time waiting at traffic lights or frequently operate in stop-and-go traffic. The vehicle 12 may enter an auto-stop mode (i.e., the engine 14 is auto-stopped) when certain vehicle propulsion conditions are met, such as when the driver has applied the brakes and the vehicle speed is below a predetermined speed threshold. Once the driver indicates a request for vehicle propulsion (e.g., by releasing the brake pedal), the control unit 28 may automatically command a restart of the engine 14.

In one embodiment, the engine 14 may be driveably connected to a crankshaft pulley that drives a belt integrated starter-generator (BISG) 29. Although a belt-drive is disclosed, other types of drives could be used to provide a driving connection between the engine 14 and the BISG 29. For example, a flexible chain drive or a geared drive could be used. The BISG 29 can be used to start the engine 14 during the stop/start sequence.

Of course, this view is highly schematic. It should be appreciated that the powertrain 10 of the vehicle 12 could employ various additional components within the scope of this disclosure. Additionally, although illustrated and described in the context of the vehicle 12, which may be a micro-hybrid vehicle, it is understood that embodiments of this disclosure could be implemented on other types of vehicles having different powertrain topologies, including full hybrid electric vehicles or even basic/entry level systems with a traditional starter motor and engine flywheel ring gear.

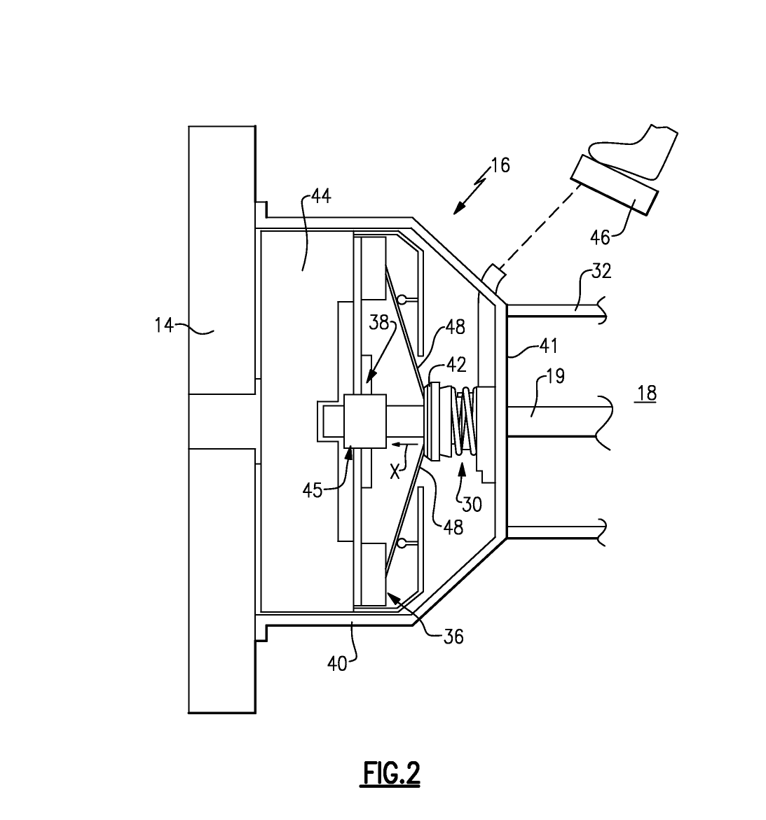

FIG. 2 illustrates a clutch system 16 that may be employed by the powertrain 10 of FIG. 1, or any other powertrain. The clutch system 16 is disposed between an engine 14 and a transmission casing 32 of a transmission 18. The clutch system 16 selectively couples the transmission 18 to the engine 14. More particularly, the clutch system 16 driveably couples the transmission input shaft 19 to a flywheel 44 of the engine 14.

In one embodiment, the clutch system 16 includes a concentric slave cylinder (CSC) assembly 30, a pressure plate 36 and a friction plate 38. The clutch system 16, including the CSC assembly 30, the pressure plate 36 and the friction plate 38, is housed within a bell housing 40. The bell housing 40 is disposed between a rear portion of the engine 14 and a forward portion of the transmission casing 32.

The transmission input shaft 19 of the transmission 18 extends into the bell housing 40 through a wall 41 of the transmission casing 32 and is concentrically surrounded by the CSC assembly 30. The transmission input shaft 19 may further extend through a thrust bearing 42 of the CSC assembly 30, and then through the friction plate 38, to selectively engage the flywheel 44 of the engine 14. The friction plate 38 is supported on the transmission input shaft 19 by a splined interface 45. The flywheel 44 may also be housed within the bell housing 40.

The CSC assembly 30 may be connected to a clutch pedal 46 located in a passenger compartment of a vehicle. Although not shown, a master cylinder may be connected between the CSC assembly 30 and the clutch pedal 46.

In operation, upon the application of pressure on the clutch pedal 46, hydraulic fluid pressure forces linear movement of the CSC assembly 30 (in the direction of arrow X in FIG. 2) such that the thrust bearing 42 contacts the pressure plate 36. As the CSC assembly 30 linearly travels, the thrust bearing 42 presses against fingers 48 to relieve the outer circumferential pressure applied against the friction plate 38 and therefore reduce the clamping pressure between the friction plate 38 and the flywheel 44. Once this clamping pressure has been relieved, the drive (or torque) from the engine 14 will be disengaged from the transmission input shaft 19 due to the decoupling of the friction plate 38 from the flywheel 44 and the pressure plate 36.

Conversely, as the clutch pedal 46 is released, the thrust bearing 42 of the CSC assembly 30 is biased in a direction opposite to the direction X to relieve the pressure being applied at the thrust bearing 42. The pressure applied against the thrust bearing 42 becomes less than the pressure on the pressure plate 36, thereby returning the fingers 48 of the pressure plate 36 to increase the clamping pressure applied to the friction plate 38 between the friction plate 38 and the flywheel 44. The transmission input shaft 19 drive or torque may then be engaged at the splined interface 45.

FIG. 2 represents but one non-limiting example of the clutch system 16. The clutch system 16 could alternatively be operated hydraulically with a cantilevered arm and a slave cylinder, via a semi-hydraulic or full cable system, or any other configuration.

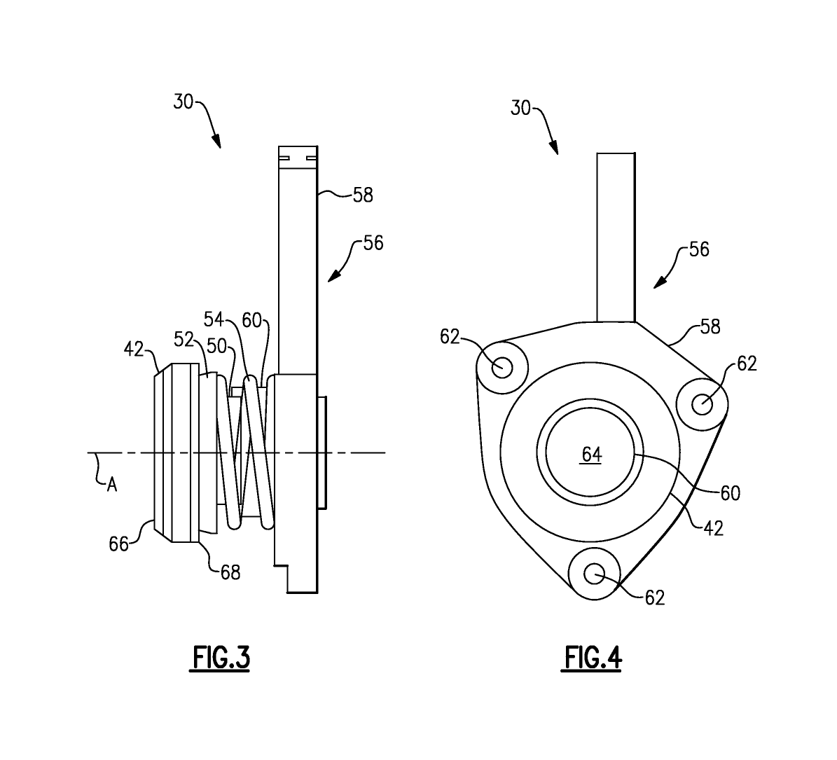

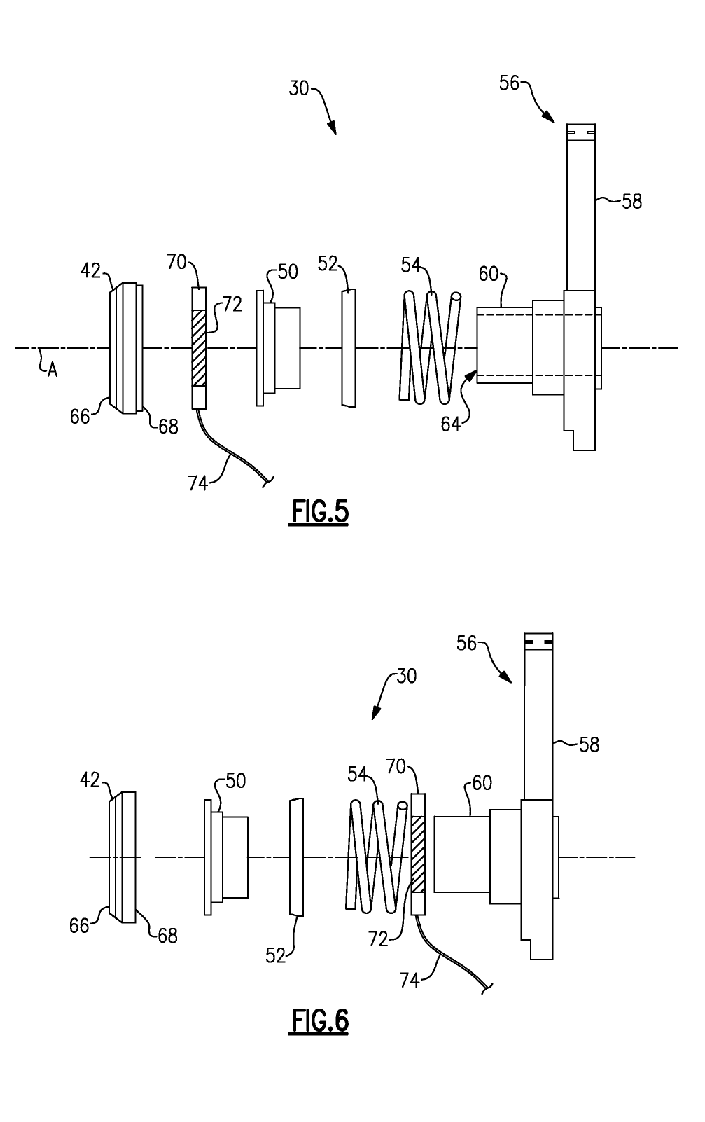

FIGS. 3, 4 and 5 illustrate an exemplary CSC assembly 30 that may be incorporated into the clutch system 16 of FIG. 2. FIG. 3 shows a side view, FIG. 4 a front view, and FIG. 5 an exploded view of the CSC assembly 30.

The exemplary CSC assembly 30 includes a thrust bearing 42, a piston 50, a dust shield 52, a spring 54 and a concentric slave cylinder (CSC) 56. The CSC 56 includes a housing 58 and a guide 60 that protrudes from the housing 58. The housing 58 may include one or more openings 62 (see FIG. 4) for mounting the CSC assembly 30. For example, the openings 62 may accommodate fasteners for securing the CSC assembly 30 to a transmission casing. There are three openings 62 shown in FIG. 4 but there could be less or more. Other methods may alternatively be used to secure the CSC assembly 30 to a transmission casing. A bore 64 extends through housing 58 and the guide 60 for accommodating a transmission input shaft (not shown in FIGS. 3, 4 and 5).

The guide 60 of the CSC 56 may be received through each of the spring 54, the dust shield 52, the piston 50 and the thrust bearing 42. In other words, each of the spring 54, the dust shield 52, the piston 50 and the thrust bearing 42 include a bore (i.e., the components are hollow) in order to accommodate the guide 60 in a concentric relationship. In one embodiment, the CSC assembly 30 is disposed about an axis A.

The spring 54 is positioned between the thrust bearing 42 and the CSC 56. In one embodiment, the spring 54 is received over the guide 60 of the CSC 56. The spring 54 exerts a biasing force against the thrust bearing 42. In one embodiment, the spring 50 is a preloaded coil spring that is biased in a direction toward the CSC 56. However, other biasing members are also contemplated as within the scope of this disclosure.

The dust shield 52 may be positioned between the thrust bearing 42 and the spring 54. The dust shield 52 may partially cover portions of the piston 50 (see, e.g., FIG. 3). The dust shield 52 is configured to block the ingress of dust or other debris into the thrust bearing 42 and other components of the CSC assembly 30.

The piston 50 is adjacent to the thrust bearing 42. The piston 50 may move to axially displace the thrust bearing 42 in response to hydraulic pressure that is applied to the CSC 56.

In one embodiment, the thrust bearing 42 includes a front face 66 and an opposing rear face 68. The front face 66 is rotatable, whereas the rear face 68 does not rotate. However, the rear face 68 can linearly travel in response to the application of hydraulic pressure applied to the CSC assembly 30.

The CSC assembly 30 may additionally include a load sensor 70 (see FIG. 5). The load sensor 70 could be positioned anywhere within the CSC assembly 30. In one embodiment, the load sensor 70 is positioned between the thrust bearing 42 and the CSC 56. In another embodiment, the load sensor 70 is positioned against the rear face 68 of the thrust bearing 42 (see FIG. 5). In yet another embodiment, the load sensor 70 is sandwiched between the housing 58 of the CSC 56 and the spring 54 (see FIG. 6). The load sensor 70 could be positioned on either side of the spring 54 and can be disposed in either a wet or a dry environment.

The load sensor 70 could include any type of sensor. In one non-limiting embodiment, the load sensor 70 is a load cell that includes one or more strain gauges and is positioned on the rear face 68 of the thrust bearing 42. The load sensor 70 could also include a multi-cell arrangement. The load sensor 70 may convert a force into an electrical signal, as discussed in additional detail below.

In one embodiment, the load sensor 70 is configured to directly measure a load applied against the front face 66 of the thrust bearing 42 during engagement/disengagement of a vehicle driveline (i.e., engagement of a transmission relative to an engine). The “load” refers to a force exerted on the thrust bearing 42 during actuation of the CSC assembly 30. The load sensor 70 enables a point of source measurement of driveline engagement/disengagement. The rear face 68 of the thrust bearing 42 will experience the same load as the front face 66 because the load applied against the front face 66 is transferred to the rear face 68 through ball bearings of the thrust bearing 42. Therefore, the load sensor 70 can directly measure loads at the front face 66 even though it is remote from and not in direct contact with the front face 66.

The load sensor 70 may also include a bore 72 (see FIGS. 5 and 6). In other words, the load sensor 70 is hollow. The bore 72 can accommodate the guide 60 of the CSC 56 to facilitate insertion of a transmission input shaft. Once assembled, the dust shield 52 may at least partially circumscribe the load sensor 70 to protect it from the relatively harsh operating environment of the clutch system (see, e.g., FIG. 3).

The load sensor 70 may be connected to a control unit (see control unit 28 of FIG. 1, for example) via wiring 74. The wiring 74 transfers load information detected by the load sensor 70, in the form of electrical signals, to a control unit for further processing.

The load information sensed by the load sensor 70 may be representative of an actual, real time driveline status of a vehicle (i.e., a preload, biting point, full load, etc.). Directly measuring these loads can improve performance of vehicles equipped with stop/start systems. For example, incorporating the load sensor 70 into the driveline for directly measuring loads at the thrust bearing 42 enables the stop/start operating range to be extended, thereby providing reductions in CO₂ and other emissions. The load information can also be used to observe clutch system wear such that applied tolerance or hysteresis factors can be eliminated to further improve the clutch system, may aid in identification of internal failures within the clutch set, or for other error detection. The control unit 28 can log an error fault code and/or illuminate a dashboard service warning light in response to identifying any such errors.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A clutch system, comprising:
a thrust bearing; and
a load sensor positioned relative to said thrust bearing and configured to measure a load exerted against said thrust bearing.

2. The clutch system as recited in claim 1, wherein said load sensor is positioned against a rear face of said thrust bearing.

3. The clutch system as recited in claim 1, wherein said thrust bearing includes a front face that is rotatable and a rear face that is not rotatable.

4. The clutch system as recited in claim 1, comprising a concentric slave cylinder includes a housing and a guide that protrudes from said housing.

5. The clutch system as recited in claim 4, wherein said guide extends through a bore of each of said thrust bearing and said load sensor.

6. The clutch system as recited in claim 1, comprising a dust shield positioned between said thrust bearing and a concentric slave cylinder.

7. The clutch system as recited in claim 1, comprising a piston positioned between said thrust bearing and a concentric slave cylinder.

8. The clutch system as recited in claim 1, comprising a spring received over a guide of a concentric slave cylinder.

9. The clutch system as recited in claim 8, wherein said load sensor is positioned between said thrust bearing and said spring.

10. The clutch system as recited in claim 8, wherein said load sensor is positioned between said spring and said concentric slave cylinder.

11. The clutch system as recited in claim 1, wherein wiring electrically connects said load sensor to a control unit of said clutch system.

12. The clutch system as recited in claim 1, wherein said load sensor is positioned remotely from a front face of said thrust bearing but is configured to measure said load applied directly at said front face.

13. A vehicle, comprising:
an engine;
a transmission operably connectable to said engine; and
a clutch system that selectively couples said transmission to said engine, said clutch system including a concentric slave cylinder assembly that includes a load sensor configured to measure a load.

14. The vehicle as recited in claim 13, wherein said load sensor is configured to measure a load exerted against a front face of a thrust bearing of said concentric slave cylinder assembly.

15. The vehicle as recited in claim 13, wherein said concentric slave cylinder assembly includes a thrust bearing, a piston, a dust shield, a spring, and a concentric slave cylinder.

16. The vehicle as recited in claim 15, wherein said load sensor is positioned between said thrust bearing and said spring.

17. The vehicle as recited in claim 15, wherein said load sensor is positioned between said spring and said concentric slave cylinder.

18. The vehicle as recited in claim 13, wherein said load sensor is positioned remotely from a front face of a thrust bearing of said concentric slave cylinder assembly.

19. The vehicle as recited in claim 13, wherein said vehicle is a micro-hybrid vehicle that includes a stop/start system for selectively shutting down said engine during idling conditions.

20. A method, comprising:
incorporating a load sensor into a clutch system of a vehicle; and
measuring a load exerted against a thrust bearing of the clutch system with the load sensor.
